(19) United States
(12) Patent Application Publication
(10) Pub. No.: US 2025/0007563 A1
(43) Pub. Date: Jan. 2, 2025

(54) Angle-of-Arrival Detection Using Reconfigurable Intelligent Surfaces

(71) Applicant: Apple Inc., Cupertino, CA (US)

(72) Inventors: Ramin Khayatzadeh, Munich (DE); Bernhard Raaf, Neuried (DE); Josef Hausner, Germering (DE)

(21) Appl. No.: 18/679,199

(22) Filed: May 30, 2024

Related U.S. Application Data
(60) Provisional application No. 63/511,573, filed on Jun. 30, 2023.

(51) Int. Cl. H04B 7/04; G01S 5/02

(52) U.S. Cl. CPC H04B 7/04013; G01S 5/0273

(57) ABSTRACT

A communication system may include an electronic device, one or more external devices, and one or more reconfigurable intelligent surfaces (RIS's). Wireless signals may be incident upon the RIS(s) from the external device(s). The RIS(s) may have antenna elements that reflect the signals towards the electronic device while being swept over a set of reflected angles. The device may include one or more antennas that receive the reflected wireless signals. The device may perform measurements of the received wireless signals and may generate a steering vector using the measurements. The device may input the steering vector to a super-resolution algorithm that outputs angles-of-arrival of the wireless signals at the RIS(s), which can be used to detect the position of the external device(s). The device may receive the wireless signals using a single antenna to minimize resource and space consumption or using multiple antennas to maximize location accuracy.

This application claims the benefit of U.S. Provisional Patent Application No. 63/511,573, filed Jun. 30, 2023, which is hereby incorporated by reference herein in its entirety.

### FIELD

This disclosure relates generally to electronic devices, including electronic devices with wireless circuitry.

### BACKGROUND

Electronic devices are often provided with wireless capabilities. An electronic device with wireless capabilities has wireless circuitry that includes one or more antennas. The wireless circuitry is used to perform communications using radio-frequency signals conveyed by the antennas.

As software applications on electronic devices become more data-intensive over time, demand has grown for electronic devices that support wireless communications at higher data rates. However, the maximum data rate supported by electronic devices is limited by the frequency of the radio-frequency signals. As the frequency of the radio-frequency signals increases, it can become increasingly difficult to perform satisfactory wireless communications because the signals become subject to significant over-the-air attenuation and typically require line-of-sight. In addition, it can sometimes be desirable to be able to detect the position of other electronic devices using the radio-frequency signals.

### SUMMARY

A communication system may include an electronic device, one or more external devices, and one or more reconfigurable intelligent surfaces (RIS's). Wireless signals (e.g., at sub-THz frequencies) may be incident upon the RIS(s) from the external device(s). The RIS(s) may have antenna elements that reflect the wireless signals towards the electronic device. The antenna elements may be swept over a set of reflected angles. The device may include one or more antennas that receive the wireless signals reflected by the RIS(s).

The device may perform measurements of the received wireless signals. The device may generate a steering vector based on the measurements. The device may input the steering vector to a super-resolution algorithm that outputs angles-of-arrival of the wireless signals at the RIS(s). The device may detect the position of the external device(s) based on the angles-of-arrival. The device may receive the wireless signals using a single antenna to minimize resource and space consumption or using multiple antennas to maximize AoA accuracy. A greater number of measurements and reflected angles may allow the device to localize a greater number of external devices. Multiple RIS's may be used to maximize the number of detectable external devices and to speed up scanning. If desired, the RIS(s) can focus the reflected signals to boost received power. If desired, one or more of the RIS(s) may be transmissive or switched into a transmissive mode.

An aspect of the disclosure provides an electronic device. The electronic device can include an antenna configured to receive wireless signals redirected by a reconfigurable intelligent surface (RIS). The electronic device can include one or more processors configured to detect, based on the wireless signals received by the antenna, an angle-of-arrival (AoA) of the wireless signals at the RIS.

An aspect of the disclosure provides a method of operating an electronic device to detect a position of one or more external devices. The method can include receiving, using one or more antennas, wireless signals reflected by a reconfigurable intelligent surface (RIS) over a set of different reflected angles. The method can include detecting, using one or more processors, the position of the one or more external devices based on the wireless signals received using the one or more antennas.

An aspect of the disclosure provides an electronic device. The electronic device can include a phased antenna array having at least a first antenna and a second antenna, each configured to receive wireless signals reflected by a reconfigurable intelligent surface (RIS) while the RIS sweeps over a set of different reflected angles at different times. The electronic device can include one or more processors. The one or more processors can be configured to perform first measurements of the wireless signals received by the first antenna. The one or more processors can be configured to perform second measurements of the wireless signals received by the second antenna. The one or more processors can be configured to detect, based on the first measurements and the second measurements, a position of at least one external device that is different from the RIS.

### BRIEF DESCRIPTION OF THE DRAWINGS

FIG. 1 is a schematic block diagram of an illustrative communications system having an electronic device that communicates with an external device via a reconfigurable intelligent surface (RIS) in accordance with some embodiments.

FIG. 2 is a diagram showing how an illustrative electronic device, RIS, and external device may communicate using both a data transfer radio access technology (RAT) and a control RAT in accordance with some embodiments.

FIG. 3 is a circuit schematic diagram of an illustrative RIS in accordance with some embodiments.

FIG. 4 is a diagram showing how an illustrative electronic device having multiple antennas can identify the angle-of-arrival (AoA) of radio-frequency signals received from an external device in accordance with some embodiments.

FIG. 5 is a diagram showing how an illustrative electronic device may use a single antenna and a RIS to identify the AoA of radio-frequency signals transmitted by one or more external devices in accordance with some embodiments.

FIG. 6 is a diagram showing how an illustrative electronic device may use multiple antennas and a RIS to identify the AoA of radio-frequency signals transmitted by one or more external devices in accordance with some embodiments.

FIG. 7 is a diagram showing how multiple RIS's may reflect radio-frequency signals towards an illustrative electronic device for detecting the AoA of the radio-frequency signals in accordance with some embodiments.

FIG. 8 is a diagram showing how an illustrative RIS may focus reflected signals in accordance with some embodiments.

FIG. 9 is a diagram showing how the antenna elements on an illustrative RIS may transmit radio-frequency signals instead of reflecting the radio-frequency signals in accordance with some embodiments.

FIG. 10 is a plot showing how the antenna elements on an illustrative RIS may be provided with different phase profiles as a function of position in accordance with some embodiments.

FIG. 11 is a flow chart of illustrative operations involved in identifying, at an electronic device, the position of one or more external devices using radio-frequency signals reflected off one or more RIS's in accordance with some embodiments.

### DETAILED DESCRIPTION

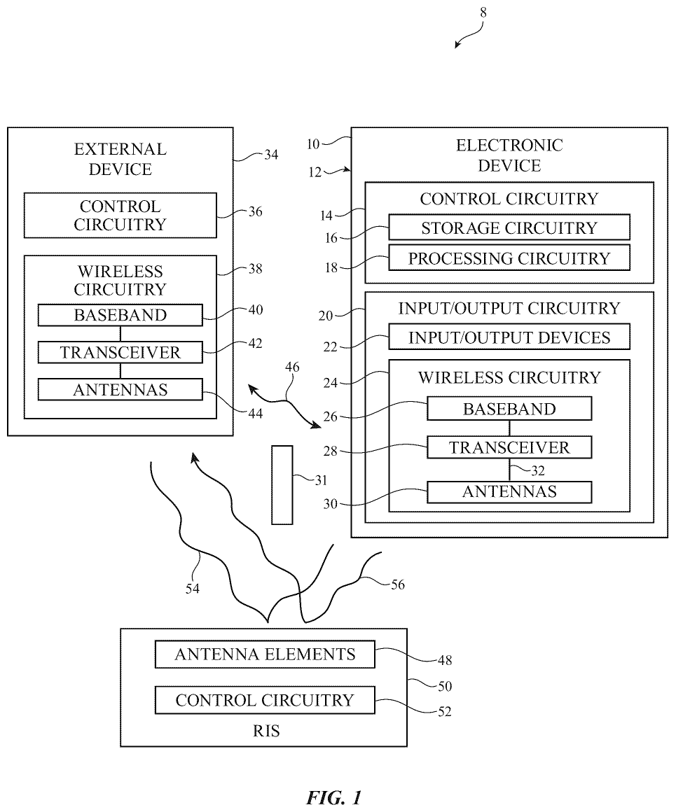

FIG. 1 is a schematic diagram of an illustrative communications system 8 (sometimes referred to herein as communications network 8) for conveying wireless data between communications terminals. Communications system 8 may include network nodes (e.g., communications terminals). The network nodes may include one or more electronic devices such as device 10. The network nodes may also include external communications equipment (e.g., communications equipment other than device 10) such as one or more external devices 34.

Device 10 may be a user equipment (UE) device, a wireless base station, a wireless access point, or other wireless equipment. When implemented as a UE device, device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head (e.g., a head-mounted display device), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, equipment that implements the functionality of two or more of these devices, or other electronic equipment.

External device 34 may be a UE device, a wireless base station, a wireless access point, or other wireless equipment. In implementations where external device 34 is a UE device, external device 34 may, if desired, be a peripheral or accessory device (e.g., a user input device, a gaming controller, a stylus, a display device, a head-mounted display, headphones, one or more earbuds, a case, etc.) for device 10 (e.g., a cellular telephone, a wristwatch, a head-mounted display, a desktop computer, a tablet computer, a laptop computer, a gaming console, a device integrated into a vehicle, etc.). These examples are illustrative and, in general, external device 34 and device 10 may include any desired wireless communications equipment or other equipment having wireless communications capabilities. Device 10 and external device 34 may communicate with each other using one or more wireless communications links. If desired, device 10 may wirelessly communicate with external device 34 without passing communications through any other intervening network nodes in communications system 8 (e.g., device 10 may communicate directly with external device 34 over-the-air).

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include baseband circuitry such as baseband circuitry 26 (e.g., one or more baseband processors and/or other circuitry that operates at baseband), radio-frequency (RF) transceiver circuitry such as transceiver 28, and one or more antennas 30. If desired, wireless circuitry 24 may include multiple antennas 30 that are arranged into a phased antenna array (sometimes referred to as a phased array antenna) that conveys radio-frequency signals within a corresponding signal beam that can be steered in different directions. Baseband circuitry 26 may be coupled to transceiver 28 over one or more baseband data paths. Transceiver 28 may be coupled to antennas 30 over one or more radio-frequency transmission line paths 32. If desired, radio-frequency front end circuitry may be disposed on radio-frequency transmission line path(s) 32 between transceiver 28 and antennas 30.

In the example of FIG. 1, wireless circuitry 24 is illustrated as including only a single transceiver 28 and a single radio-frequency transmission line path 32 for the sake of clarity. In general, wireless circuitry 24 may include any desired number of transceivers 28, any desired number of radio-frequency transmission line paths 32, and any desired number of antennas 30. Each transceiver 28 may be coupled to one or more antennas 30 over respective radio-frequency transmission line paths 32. Radio-frequency transmission line path 32 may be coupled to antenna feeds on one or more antenna 30. Each antenna feed may, for example, include a positive antenna feed terminal and a ground antenna feed terminal. Radio-frequency transmission line path 32 may have a positive transmission line signal path that is coupled to the positive antenna feed terminal and may have a ground transmission line signal path that is coupled to the ground antenna feed terminal. This example is merely illustrative and, in general, antennas 30 may be fed using any desired antenna feeding scheme.

Radio-frequency transmission line path 32 may include transmission lines that are used to route radio-frequency antenna signals within device 10. Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 32 may be integrated into rigid and/or flexible printed circuit boards. In one embodiment, radio-frequency transmission line paths such as radio-frequency transmission line path 32 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

In performing wireless transmission, baseband circuitry 26 may provide baseband signals to transceiver 28 (e.g., baseband signals that include wireless data for transmission). Transceiver 28 may include circuitry for converting the baseband signals received from baseband circuitry 26 into corresponding radio-frequency signals (e.g., for modulating the wireless data onto one or more carriers for transmission, synthesizing a transmit signal, etc.). For example, transceiver 28 may include mixer circuitry for up-converting the baseband signals to radio frequencies prior to transmission over antennas 30. Transceiver 28 may also include digital to analog converter (DAC) and/or analog to digital converter (ADC) circuitry for converting signals between digital and analog domains. Transceiver 28 may transmit the radio-frequency signals over antennas 30 via radio-frequency transmission line path 32. Antennas 30 may transmit the radio-frequency signals to external wireless equipment by radiating the radio-frequency signals into free space.

In performing wireless reception, antennas 30 may receive radio-frequency signals from external device 34. The received radio-frequency signals may be conveyed to transceiver 28 via radio-frequency transmission line path 32. Transceiver 28 may include circuitry for converting the received radio-frequency signals into corresponding baseband signals. For example, transceiver 28 may include mixer circuitry for down-converting the received radio-frequency signals to baseband frequencies prior to conveying the baseband signals to baseband circuitry 26 and may include demodulation circuitry for demodulating wireless data from the received signals.

Front end circuitry disposed on radio-frequency transmission line path 32 may include radio-frequency front end components that operate on radio-frequency signals conveyed over radio-frequency transmission line path 32. If desired, the radio-frequency front end components may be formed within one or more radio-frequency front end modules (FEMs). Each FEM may include a common substrate such as a printed circuit board substrate for each of the radio-frequency front end components in the FEM. The radio-frequency front end components in the front end circuitry may include switching circuitry (e.g., one or more radio-frequency switches), radio-frequency filter circuitry (e.g., low pass filters, high pass filters, notch filters, band pass filters, multiplexing circuitry, duplexer circuitry, diplexer circuitry, triplexer circuitry, etc.), impedance matching circuitry (e.g., circuitry that helps to match the impedance of antennas 30 to the impedance of radio-frequency transmission line path 32), antenna tuning circuitry (e.g., networks of capacitors, resistors, inductors, and/or switches that adjust the frequency response of antennas 30), radio-frequency amplifier circuitry (e.g., power amplifier circuitry and/or low-noise amplifier circuitry), radio-frequency coupler circuitry, charge pump circuitry, power management circuitry, digital control and interface circuitry, and/or any other desired circuitry that operates on the radio-frequency signals transmitted and/or received by antennas 30.

While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, baseband circuitry 26 and/or portions of transceiver 28 (e.g., a host processor on transceiver 28) may form a part of control circuitry 14. Baseband circuitry 26 may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of antenna currents on an antenna resonating (radiating) element in the antenna by the wireless signals within the frequency band(s) of operation of the antenna.

Transceiver circuitry 28 may use antenna(s) 30 to transmit and/or receive wireless signals that convey wireless communications data between device 10 and external device 34. The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Additionally or alternatively, wireless circuitry 24 may use antenna(s) 30 to perform wireless (radio-frequency) sensing operations. The sensing operations may allow device 10 to detect (e.g., sense or identify) the presence, location, orientation, and/or velocity (motion) of objects external to device 10. Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc. The sensing operations may, for example, involve the transmission of sensing signals (e.g., radar waveforms), the receipt of corresponding reflected signals (e.g., the transmitted waveforms that have reflected off of external objects), and the processing of the transmitted signals and the received reflected signals (e.g., using a radar scheme).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands at sub-THz or THz frequencies greater than about 100 GHz, etc.), other centimeter or millimeter wave frequency bands between 10-100 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-100 Gbps or higher, wireless circuitry 24 may convey wireless signals at frequencies greater than about 100 GHz.

As shown in FIG. 1, wireless circuitry 24 may transmit wireless signals 46 to external device 34 and/or may receive wireless signals 46 from external device 34. Wireless signals 46 may be tremendously high frequency (THF) signals (e.g., sub-THz or THz signals) at frequencies greater than or equal to around 100 GHz (e.g., between 100 GHz and 1 THz, between 80 GHz and 10 THz, between 100 GHz and 10 THz, between 100 GHz and 2 THz, between 200 GHz and 1 THz, between 300 GHz and 1 THz, between 300 GHz and 2 THz, between 70 GHz and 2 THz, between 300 GHz and 10 THz, between 100 GHz and 800 GHz, between 200 GHz and 1.5 THz, or within any desired sub-THz, THz, THF, or sub-millimeter frequency band such as a 6G frequency band), may be millimeter (mm) or centimeter (cm) wave signals between 10 GHz and around 70 GHz (e.g., 5G NR FR2 signals), or may be signals at frequencies less than 10 GHz (e.g., 5G NR FR1 signals, LTE signals, 3G signals, 2G signals, WLAN signals, Bluetooth signals, UWB signals, etc.).

If desired, the high data rates supported by THF signals may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

In implementations where wireless circuitry 24 conveys THF signals, the wireless circuitry may include electro-optical circuitry if desired. The electro-optical circuitry may include light sources that generate first and second optical local oscillator (LO) signals. The first and second optical LO signals may be separated in frequency by the intended frequency of wireless signals 46. Wireless data may be modulated onto the first optical LO signal and one of the optical LO signals may be provided with an optical phase shift (e.g., to perform beamforming). The first and second optical LO signals may illuminate a photodiode that produces current at the frequency of wireless signals 46 when illuminated by the first and second optical LO signals. An antenna resonating element of a corresponding antenna 30 may convey the current produced by the photodiode and may radiate corresponding wireless signals 46. This is merely illustrative and, in general, wireless circuitry 24 may generate wireless signals 46 using any desired techniques.

Antennas 30 may be formed using any desired antenna structures. For example, antennas 30 may include antennas with resonating elements that are formed from loop antenna structures, patch antenna structures, inverted-F antenna structures, slot antenna structures, planar inverted-F antenna structures, helical antenna structures, monopole antennas, dipoles (e.g., planar dipole antennas such as bowtie antennas), hybrids of these designs, etc. Parasitic elements may be included in antennas 30 to adjust antenna performance.

If desired, two or more of antennas 30 may be integrated into a phased antenna array (sometimes referred to herein as a phased array antenna or an array of antenna elements). Each antenna 30 in the phased antenna array forms a respective antenna element of the phased antenna array. Each antenna 30 in the phased antenna array has a respective phase and magnitude controller that imparts the radio-frequency signals conveyed by that antenna with a respective phase and magnitude. The respective phases and magnitudes may be selected (e.g., by control circuitry 14) to configure the radio-frequency signals conveyed by the antennas 30 in the phased antenna array to constructively and destructively interfere in such a way that the radio-frequency signals collectively form a signal beam (e.g., a signal beam of wireless signals 46) oriented in a corresponding beam pointing direction (e.g., a direction of peak gain).

The control circuitry may adjust the phases and magnitudes to change (steer) the orientation of the signal beam (e.g., the beam pointing direction) to point in other directions over time. This process may sometimes also be referred to herein as beamforming. Beamforming may boost the gain of wireless signals 46 to help overcome over-the-air attenuation and the signal beam may be steered over time to point towards external device 34 even as the position and orientation of device 10 changes. The signal beams formed by antennas 30 of device 10 may sometimes be referred to herein as device beams or device signal beams. Each device beam may be oriented in a different respective direction (e.g., a beam pointing direction of peak signal gain). Each device beam may be labeled by a corresponding device beam index. Device 10 may include or store a codebook that maps each of its device beam indices to the corresponding phase and magnitude settings for each antenna 30 in a phased antenna array that configure the phased antenna array to form the device beam associated with that device beam index.

As shown in FIG. 1, external device 34 may also include control circuitry 36 (e.g., control circuitry having similar components and/or functionality as control circuitry 14 in device 10) and wireless circuitry 38 (e.g., wireless circuitry having similar components and/or functionality as wireless circuitry 24 in device 10). If desired, external device 34 may include input/output devices (not shown in FIG. 1 for the sake of clarity) such as input/output devices 22 of device 10. Wireless circuitry 38 may include baseband circuitry 40 and transceiver 42 (e.g., transceiver circuitry having similar components and/or functionality as transceiver circuitry 28 in device 10) coupled to two or more antennas 44 (e.g., antennas having similar components and/or functionality as antennas 30 in device 10). Antennas 44 may be arranged in one or more phased antenna arrays (e.g., phased antenna arrays that perform beamforming similar to phased antenna arrays of antennas 30 on device 10).

External device 34 may use wireless circuitry 38 to transmit a signal beam of wireless signals 46 to device 10 and/or to receive a signal beam of wireless signals 46 transmitted by device 10. The signal beams formed by antennas 44 of external device 34 may sometimes be referred to herein as external device beams or external device signal beams. Each external device beam may be oriented in a different respective direction (e.g., a beam pointing direction of peak signal gain). Each external device beam may be labeled by a corresponding external device beam index. External device 34 may include or store a codebook that maps each of its external device beam indices to the corresponding phase and magnitude settings for each antenna 44 in a phased antenna array that configure the phased antenna array to form the external device beam associated with that external device beam index.

While communications at high frequencies allow for extremely high data rates (e.g., greater than 100 Gbps), wireless signals 46 at such high frequencies are subject to significant attenuation during propagation over-the-air. Integrating antennas 30 and 44 into phased antenna arrays helps to counteract this attenuation by boosting the gain of the signals within a signal beam. However, signal beams are highly directive and may require a line-of-sight (LOS) between device 10 and external device 34. If an external object is present between external device 34 and device 10, the external object may block the LOS between device 10 and external device 34, which can disrupt wireless communications using wireless signals 46. If desired, a reflective device such as a reconfigurable intelligent surface (RIS) may be used to allow device 10 and external device 34 to continue to communicate using wireless signals 46 even when an external object blocks the LOS between device 10 and external device 34 (or whenever direct over-the-air communications between external device 34 and device 10 otherwise exhibits less than optimal performance).

As shown in FIG. 1, system 8 may include one or more reconfigurable intelligent surfaces (RIS's) such as RIS 50. RIS 50 may sometimes also be referred to as an intelligent reconfigurable surface, an intelligent reflective/reflecting surface, a reflective intelligent surface, a reflective surface, a reflective device, a reconfigurable reflective device, a reconfigurable reflective surface, or a reconfigurable surface. External device 34 may be separated from device 10 by a line-of-sight (LOS) path. In some circumstances, an external object such as object 31 may block the LOS path. Object 31 may be, for example, part of a building such as a wall, window, floor, or ceiling (e.g., when device 10 is located inside), furniture, a body or body part, an animal, a cubicle wall, a vehicle, a landscape feature, or other obstacles or objects that may block the LOS path between external device 34 and device 10.

In the absence of external object 31, external device 34 may form a corresponding external device beam of wireless signals 46 oriented in the direction of device 10 and device 10 may form a corresponding device beam of wireless signals 46 oriented in the direction of external device 34. Device 10 and external device 34 can then convey wireless signals 46 over their respective signal beams and the LOS path. However, the presence of external object 31 prevents wireless signals 46 from being conveyed over the LOS path.

RIS 50 may be placed or disposed within system 8 so as to allow RIS 50 to redirect (e.g., reflect and/or transmit) wireless signals 46 between device 10 and external device 34 despite the presence of external object 31 within the LOS path. More generally, RIS 50 may be used to reflect wireless signals 46 between device 10 and external device 34 when reflection via RIS 50 offers superior radio-frequency propagation conditions relative to the LOS path regardless of the presence of external object 31 (e.g., when the LOS path between external device 34 and RIS 50 and the LOS path between RIS 50 and device 10 exhibit superior propagation/channel conditions than the direct LOS path between device 10 and external device 34). While RIS 50 may additionally or alternatively transmit wireless signals 46 in different directions (e.g., by imparting different phases to incident wireless signals 46 that are redirected, via passive transmission, by RIS 50 within the hemisphere opposite to that which the RIS received the signals, as if the RIS were transparent to the signals), implementations in which RIS 50 reflects wireless signals 46 between device 10 and external device 34 are illustrated and described herein as an example for the sake of simplicity and conciseness.

When RIS 50 is placed within system 8, external device 34 may transmit wireless signals 46 towards RIS 50 (e.g., within an external device beam oriented towards RIS 50 rather than towards device 10) and RIS 50 may reflect the wireless signals towards device 10, as shown by arrow 54. Conversely, device 10 may transmit wireless signals 46 towards RIS 50 (e.g., within a device beam oriented towards RIS 50 rather than towards external device 34) and RIS 50 may reflect the wireless signals towards external device 34, as shown by arrow 56.

RIS 50 is an electronic device that includes a one or two-dimensional surface of engineered material having reconfigurable properties for performing (e.g., reflecting) communications between external device 34 and device 10. RIS 50 may include an array of reflective elements such as antenna elements 48 on an underlying substrate. Antenna elements 48 may also sometimes be referred to herein as reflective elements 48, reconfigurable antenna elements 48, reconfigurable reflective elements 48, reflectors 48, or reconfigurable reflectors 48. Antenna elements 48 may be arranged in a one-dimensional array or a two-dimensional array. When implemented in a one-dimensional array, antenna elements 48 may be arranged linearly (e.g., as Uniform Linear Array (ULA)), circularly (e.g., as a circular array), or along a linear manifold. When implemented in a two-dimensional array, antenna elements 48 may be arranged in a plane, in a curved surface (e.g., on a dome to obtain more omni-directional coverage), or in any two-dimensional manifold. If desired, antenna elements 48 may even be arranged three dimensionally (e.g., on the vertices of a 3D lattice structure).

The substrate may be a rigid or flexible printed circuit board, a package, a plastic substrate, meta-material, or any other desired substrate. The substrate may be planar or may be curved in one or more dimensions. If desired, the substrate and antenna elements 48 may be enclosed within a housing. The housing may be formed from materials that are transparent to wireless signals 46. If desired, RIS 50 may be disposed (e.g., layered) on an underlying electronic device. RIS 50 may also be provided with mounting structures (e.g., adhesive, brackets, a frame, screws, pins, clips, etc.) that can be used to affix or attach RIS 50 to an underlying structure such as another electronic device, a wall, the ceiling, the floor, furniture, etc. Disposing RIS 50 on a ceiling, wall, window, column, pillar, or at or adjacent to the corner of a room (e.g., a corner where two walls intersect, where a wall intersects with the floor or ceiling, where two walls and the floor intersect, or where two walls and the ceiling intersect), as examples, may be particularly helpful in allowing RIS 50 to reflect wireless signals between external device 34 and device 10 around various objects 31 that may be present (e.g., when external device 34 is located outside and device 10 is located inside, when external device 34 and device 10 are both located inside or outside, etc.).

RIS 50 may be a passive adaptively controlled reflecting surface and a powered device that includes control circuitry 52 that helps to control the operation of antenna elements 48 (e.g., one or more processors in control circuitry such as control circuitry 14). When electro-magnetic (EM) energy waves (e.g., waves of wireless signals 46) are incident on RIS 50, the wave is reflected by each antenna element 48 via re-radiation by each antenna element 48 with a respective phase and amplitude response. Antenna elements 48 may include passive reflectors (e.g., antenna resonating elements or other radio-frequency reflective elements). Each antenna element 48 may include an adjustable device that is programmed, set, and/or controlled by control circuitry 52 (e.g., using a control signal that includes or represents a respective beamforming coefficient) to configure that antenna element 48 to reflect incident EM energy with the respective phase and amplitude response (e.g., with a respective reflection coefficient). The adjustable device may be a programmable photodiode, an adjustable impedance matching circuit, an adjustable phase shifter, an adjustable amplifier, a varactor diode, an antenna tuning circuit, combinations of these, etc.

Control circuitry 52 on RIS 50 may configure the reflective response of antenna elements 48 on a per-element or per-group-of-elements basis (e.g., where each antenna element has a respective programmed phase and amplitude response or the antenna elements in different sets/groups of antenna elements are each programmed to share the same respective phase and amplitude response across the set/group but with different phase and amplitude responses between sets/groups). The scattering, absorption, reflection, transmission, and diffraction properties of the entire RIS can therefore be changed over time and controlled (e.g., by software running on the RIS or other devices communicably coupled to the RIS such as external device 34 or device 10).

One way of achieving the per-element phase and amplitude response of antenna elements 48 is by adjusting the impedance of antenna elements 48, thereby controlling the complex reflection coefficient that determines the change in amplitude and phase of the re-radiated signal. The control circuitry 52 on RIS 50 may configure antenna elements 48 to exhibit impedances that serve to reflect wireless signals 46 incident from particular incident angles onto particular output angles. The antenna elements 48 (e.g., the antenna impedances) may be adjusted to change the angle with which incident wireless signals 46 are reflected off of RIS 50.

For example, the control circuitry on RIS 50 may configure antenna elements 48 to reflect wireless signals 46 transmitted by external device 34 towards device 10 (as shown by arrow 54) and to reflect wireless signals 46 transmitted by device 10 towards external device 34 (as shown by arrow 56). In such an example, control circuitry 36 may configure (e.g., program) a phased antenna array of antennas 44 on external device 34 to form an external device beam oriented towards RIS 50, control circuitry 14 may configure (e.g., program) a phased antenna array of antennas 30 on device 10 to form a device beam oriented towards RIS 50, control circuitry 52 may configure (e.g., program) antenna elements 48 to receive and re-radiate (e.g., effectively reflect or redirect) wireless signals incident from the direction of external device 34 towards/onto the direction of device 10 (as shown by arrow 54), and control circuitry 52 may configure (e.g., program) antenna elements 48 to receive and re-radiate (e.g., effectively reflect) wireless signals incident from the direction of device 10 towards/onto the direction of external device 34 (as shown by arrow 56). The antenna elements may be configured using respective beamforming coefficients. Control circuitry 52 on RIS 50 may set and adjust the adjustable devices coupled to antenna elements 48 (e.g., may set and adjust the impedances of antenna elements 48) over time to reflect wireless signals 46 incident from different selected incident angles onto different selected output angles.

To minimize the cost, complexity, and power consumption of RIS 50, RIS 50 may include only the components and control circuitry required to control and operate antenna elements 48 to reflect wireless signals 46. Such components and control circuitry may include, for example, the adjustable devices of antenna elements 48 as required to change the phase and magnitude responses of antenna elements 48 (based on corresponding beamforming coefficients) and thus the direction with which RIS 50 reflects wireless signals 46. The components may include, for example, components that adjust the impedances of antenna elements 48 so that each antenna element exhibits a respective complex reflection coefficient, which determines the phase and amplitude of the reflected (re-radiated) signal produced by each antenna element (e.g., such that the signals reflected across the array constructively and destructively interfere to form a reflected signal beam in a corresponding beam pointing direction).

All other components that would otherwise be present in device 10 or external device 34 may be omitted from RIS 50. For example, RIS 50 may be free from baseband circuitry (e.g., baseband circuitry 26 or 40) and/or transceiver circuitry (e.g., transceiver 42 or 28) coupled to antenna elements 48. Antenna elements 48 and RIS 50 may therefore be incapable of generating wireless data for transmission, synthesizing radio-frequency signals for transmission, and/or receiving and demodulating incident radio-frequency signals. RIS 50 may also be implemented without a display or user input device. In other words, the control circuitry on RIS 50 may adjust antenna elements 48 to direct and steer reflected wireless signals 46 without using antenna elements 48 to perform any data transmission or reception operations and without using antenna elements 48 to perform radio-frequency sensing operations. In other implementations, the RIS may include some active circuitry such as circuitry for demodulating received signals using the data RAT (e.g., to perform channel estimates for optimizing its reflection coefficients).

This may serve to minimize the hardware cost and power consumption of RIS 50. If desired, RIS 50 may also include one or more antennas (e.g., antennas separate from the antenna elements 48 used to reflect wireless signals 46) and corresponding transceiver/baseband circuitry that uses the one or more antennas to convey control signals with external device 34 or device 10 (e.g., using a control channel plane and control RAT). Such control signals may be used to coordinate the operation of RIS 50 in conjunction with external device 34 and/or device 10 but requires much lower data rates and thus much fewer processing resources and much less power than transmitting or receiving wireless signals 46. These control signals may, for example, be transmitted by device 10 and/or external device 34 to configure the phase and magnitude responses of antenna elements 48 (e.g., the control signals may convey beamforming coefficients). This may allow the calculation of phase and magnitude responses for antenna elements 48 to be offloaded from RIS 50, further reducing the processing resources and power required by RIS 50. In other implementations, RIS 50 may be a self-controlled RIS that includes processing circuitry for generating its own phase and magnitude responses and/or for coordinating communications among multiple devices (e.g., in a RIS-as-a-service configuration).

In this way, RIS 50 may help to relay wireless signals 46 between external device 34 and device 10 when object 31 blocks the LOS path between external device 34 and device 10 and/or when the propagation conditions from external device 34 to RIS 50 and from RIS 50 to device 10 are otherwise superior to the propagation conditions from external device 34 to device 10. Just a single RIS 50 may, for example, increase signal-to-interference-plus-noise ratio (SINR) for device 10 by as much as +20 dB and may increase effective channel rank relative to environments without an RIS. At the same time, RIS 50 may include only the processing resources and may consume only the power required to perform control procedures, minimizing the cost of RIS 50 and maximizing the flexibility with which RIS 50 can be placed within the environment.

RIS 50 may include or store a codebook (sometimes referred to herein as a RIS codebook) that maps settings for antenna elements 48 to different reflected signal beams formable by antenna elements 48 (sometimes referred to herein as RIS beams). RIS 50 may configure its own antenna elements 48 to perform beamforming with respective beamforming coefficients (e.g., as given by the RIS codebook). The beamforming performed at RIS 50 may include two concurrently active RIS beams (e.g., where each RIS beam is generated using a corresponding set of beamforming coefficients) or equivalently, a single reflected beam having an incident and output angle relative to a lateral surface of the RIS. While referred to herein as “beams,” the RIS beams formed by RIS 50 do not include signals/data that are actively transmitted by RIS 50 but instead correspond to the impedance, phase, and/or magnitude response settings (e.g., reflection coefficients) for antenna elements 48 that shape the reflected signal beam of wireless signals 46 from a corresponding incident direction/angle onto a corresponding output direction/angle (e.g., one RIS beam may be effectively formed using a first set of beamforming coefficients whereas another RIS beam may be effectively formed using a second set of beamforming coefficients).

In general, RIS 50 may relay (reflect) signals between two different devices or may reflect signals transmitted by a single device back to that device. RIS 50 may form a first active RIS beam that has a beam pointing direction oriented towards the first device (sometimes referred to here as a RIS-external device beam when the first device is external device 34) and may concurrently form a second active RIS beam that has a beam pointing direction oriented towards the second device (sometimes referred to herein as a RIS-device beam when the second device is device 10). In this way, when wireless signals 46 are incident from the first device (e.g., external device 34) within the first RIS beam, the antenna elements 48 on RIS 50 may receive the wireless signals incident from the direction the first device (e.g., external device 34) and may re-radiate (e.g., effectively reflect) the incident wireless signals within the second RIS beam and towards the direction of the second device (e.g., device 10). Conversely, when wireless signals 46 are incident from the second device (e.g., device 10) within the second RIS beam, the antenna elements 48 on RIS 50 may receive the wireless signals incident from the direction the second device (e.g., device 10) and may re-radiate (e.g., effectively reflect) the incident wireless signals within the first RIS beam and towards the direction of the first device (e.g., external device 34). If desired, the first and second RIS beams may be oriented in the same direction to reflect incident signals back in the direction the signals were received from.

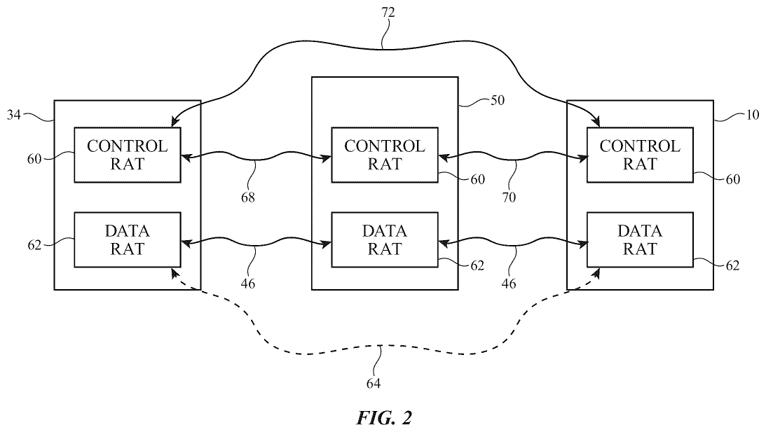

FIG. 2 is a diagram showing how external device 34, RIS 50, and device 10 may communicate using both a control RAT and a data transfer RAT for establishing and maintaining communications between external device 34 and device 10 via RIS 50. As shown in FIG. 2, external device 34, RIS 50, and device 10 may each include wireless circuitry that operates according to a data transfer RAT 62 (sometimes referred to herein as data RAT 62) and a control RAT 60. Data RAT 62 may be a sub-THz communications RAT such as a 6G RAT that performs wireless communications at the frequencies of wireless signals 46. Control RAT 60 may be associated with wireless communications that consume much fewer resources and are less expensive to implement than the communications of data RAT 62. For example, control RAT 60 may be Wi-Fi, Bluetooth, a cellular telephone RAT such as a 3G, 4G, or 5G NR FR1 RAT, etc. As another example control RAT 60 may be an infrared communications RAT (e.g., where an infrared remote control or infrared emitters and sensors use infrared light to convey signals for the control RAT between device 10, external device 34, and/or RIS 50).

External device 34 and RIS 50 may use control RAT 60 to convey radio-frequency signals 68 (e.g., control signals) between external device 34 and RIS 50. Device 10 and RIS 50 may use control RAT 60 to convey radio-frequency signals 70 (e.g., control signals) between device 10 and RIS 50. Device 10, external device 34, and RIS 50 may use data RAT 62 to convey wireless signals 46 via reflection off antenna elements 48 of RIS 50. The wireless signals may be reflected, via the first RIS beam and the second RIS beam formed by RIS 50, between external device 34 and device 10. External device 34 may use radio-frequency signals 68 and control RAT 60 and/or device 10 may use radio-frequency signals 70 and control RAT 60 to discover RIS 50 and to configure antenna elements 48 to establish and maintain the relay of wireless signals 46 performed by antenna elements 48 using data RAT 62.

If desired, external device 34 and device 10 may also use control RAT 60 to convey radio-frequency signals 72 directly with each other (e.g., since the control RAT operates at lower frequencies that do not require line-of-sight). Device 10 and external device 34 may use radio-frequency signals 72 to help establish and maintain THF communications (communications using data RAT 62) between device 10 and external device 34 via RIS 50. External device 34 and device 10 may also use data RAT 62 to convey wireless signals 46 directly (e.g., without reflection off RIS 50) when a LOS path is available (as shown by path 64).

If desired, the same control RAT 60 may be used to convey radio-frequency signals 68 between external device 34 and RIS 50 and to convey radio-frequency signals 70 between RIS 50 and device 10. If desired, external device 34, RIS 50, and/or device 10 may support multiple control RATs 60. In these scenarios, a first control RAT 60 (e.g., Bluetooth) may be used to convey radio-frequency signals 68 between external device 34 and RIS 50, a second control RAT 60 (e.g., Wi-Fi) may be used to convey radio-frequency signals 70 between RIS 50 and device 10, and/or a third control RAT 60 may be used to convey radio-frequency signals 72 between external device 34 and device 10. Processing procedures (e.g., work responsibilities) may be divided between data RAT 62 one or more control RAT 60 during discovery, initial configuration, data RAT communication between device 10 and external device 34 via RIS 50, and beam tracking of device 10.

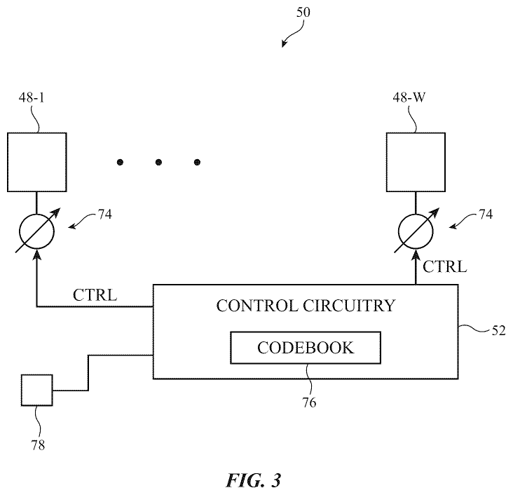

FIG. 3 is a diagram of RIS 50. As shown in FIG. 3, RIS 50 may include a set of W antenna elements 48 (e.g., a first antenna element 48-1, a Wth antenna element 48-W, etc.). Antenna elements 48 may include patches, monopoles, dipoles, inverted-F elements, planar inverted-F elements, slots, or other structures formed from metal or metamaterials/metastructures on an underlying substrate. The W antenna elements 48 may be arranged in an array pattern. The antenna elements 48 on RIS 50 may have sub-wavelength spacing and may each have a sub-wavelength width/size. The array pattern may have rows and columns. Other array patterns may be used if desired. Each antenna element 48 may be coupled to a corresponding adjustable device 74. Adjustable devices 74 may include, as one example, a diode switch. Each adjustable device 74 and its corresponding antenna element 48 may sometimes be referred to herein as a unit cell of RIS 50 (e.g., RIS 50 may have W unit cells).

Control circuitry 52 may provide respective control signals CTRL (e.g., variable voltages) to adjustable devices 74 that configure each adjustable device 74 to impart a selected impedance to its corresponding antenna element 48. The impedance may effectively impart a corresponding phase shift to incident THF signals that are scattered (e.g., re-radiated or effectively reflected) by the antenna element. Adjustable devices 74 may therefore sometimes be referred to herein as phase shifters 74.

Control circuitry 52 may transmit control signals CTRL to adjustable devices 74 to control each adjustable device 74 to exhibit a corresponding phase setting and thus a corresponding reflection coefficient (beamforming coefficient). The control signal CTRL provided to each adjustable device 74 may identify, contain, carry, or otherwise represent the corresponding phase setting, reflection coefficient, or beamforming coefficient. Each phase setting (beamforming coefficient) may cause the corresponding antenna element 48 to impart a particular phase shift to the wireless signals 46 scattered (reflected) by the antenna element for data RAT 62. Put differently, each phase setting may configure the corresponding antenna element 48 to exhibit a particular reflection coefficient or impedance for incident THF signals. By selecting the appropriate settings (phase shift settings, applied phase shifts, or beamforming coefficients) for adjustable devices 74, the array of antenna elements 48 may be configured to collectively form RIS beams in different directions (e.g., to reflect/scatter wireless signals incident from incident angles associated with a first RIS beam onto corresponding output angles associated with a second RIS beam).

As shown in FIG. 3, RIS 50 may have one or more antennas 78. Antenna(s) 78 may include one or more of the W antenna elements 48 or may be separate from the W antenna elements 48 on RIS 50. Antenna(s) 78 may be coupled to a control RAT transceiver on RIS 50 and may be used to convey control signals over control RAT 60. Control circuitry 52 may transmit control signals using antenna(s) 78 and/or may receive control signals using antenna(s) 78.

Control circuitry 52 may store a codebook 76 that maps different sets of settings (e.g., phase settings) for adjustable devices 74 to different input/output angles (e.g., to different combinations of first and second RIS beams for RIS 50). Codebook 76 may be populated during manufacture, deployment, calibration, and/or regular operation of RIS 50. Codebook 76 may be stored on storage circuitry or memory on RIS 50. If desired, external device 34, device 10, or a dedicated controller may use control RAT 60 to populate and/or update the entries of codebook 76. During operation, RIS 50 may be controlled to configure (program) adjustable devices 74 to form the RIS beams necessary for RIS 50 to reflect wireless signals 46 between the location of external device 34 and the location of device 10, which may change over time. This may involve selection (calculation) of the appropriate set of phase settings (e.g., imparted phase shifts or reflection coefficients) for adjustable devices 74 to form the RIS beams.

RIS 50 may dynamically change the phase settings (reflection coefficients) of antenna elements 48 over time (e.g., to direct reflected signals in different directions to serve one or more external devices 34 as the position of the external device(s) and/or device 10 changes over time). If desired, RIS 50 may be at least partially controlled by a remote controller located on an external device other than RIS 50. The remote controller may be located on an electronic device such as external device 34, device 10, a dedicated RIS controller, and/or other nodes of system 8 (FIG. 1). The remote controller may be distributed across multiple devices or network nodes if desired.

It may be desirable for network nodes of system 8 (e.g., device 10, external device 34, etc.) to be able to detect their physical locations (positions) and/or the physical locations (positions) of one or more other network nodes using wireless signals 46 that are transmitted and received between the network nodes. For example, it may be desirable for device 10 to detect the position of one or more external devices 34 using wireless signals 46 received from the external device(s) (a process sometimes referred to herein as localization or positioning).

Accurate indoor/outdoor localization of external device 34 by device 10 is important for many potential applications of system 8 (e.g., internet-of-things applications, sensing applications, automated driving applications, 6G communications in which high accuracy beamforming is required to maintain a satisfactory wireless link, joint communication and sensing applications, virtual/mixed/augmented reality applications requiring positioning or orientation information and high data rate communications, etc.). One technique that device 10 may use to localize external device 34 is detection of the time-of-flight (TOF) and angle-of-arrival AoA of the wireless signals 46 received by device 10 from external device 34.

Device 10 may, for example, use the TOF measurements to detect the range between device 10 and external device 34 (e.g., where range is determined by the known propagation speed of wireless signals 46 and the difference between a timestamp identifying the time when external device 34 transmitted the wireless signals and the time when device 10 receives the wireless signals). Range alone may allow device 10 to identify a circle around device 10 on which external device 34 may be located. Device 10 may use the AoA measurements to detect the orientation or angle to/from external device 34 relative to device 10 (e.g., to resolve a particular location on the circle centered around device 10 at which external device 34 is located). When combined with range, AoA may allow device 10 to have complete knowledge of the position (e.g., in three-dimensional spatial coordinates) of external device 34 relative to device 10.

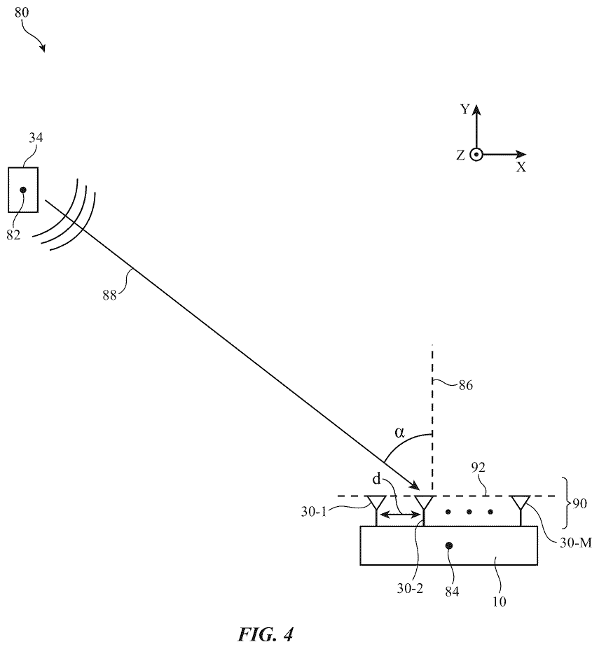

In some implementations, machine learning or artificial intelligence algorithms are used to perform localization. However, machine learning and artificial intelligence require excessively large training measurement sets which can make such solutions impractical for large areas. In addition, accurately measuring AoA can require a large number of antennas 30 arranged in a phased antenna array in device 10. FIG. 4 is a diagram showing how device 10 may detect the AoA to external device 34 using a phased antenna array of antennas 30 and wireless signals 46 transmitted by external device 34.

As shown in FIG. 4, device 10 may be at a first spatial location 84 within a geographic area (region) 80. Area 80 may be indoors, may be outdoors, or may include both indoor and outdoor environments. External device 34 may be at a second spatial location 82 within area 80. Device 10 may have no a priori knowledge of the location 82 of external device.

During localization operations, device 10 may receive wireless signals 46 (e.g., data RAT signals) from external device 34, which are incident upon device 10 in the direction of arrow 88. The wireless signals 46 incident in the direction of arrow 88 may be transmitted by external device 34 or, if desired, may be transmitted by device 10 and reflected off external device 34 back towards device 10 in the direction of arrow 88 (e.g., wireless signals 46 may include communications data, reference signal waveforms, radar waveforms, or any other desired waveforms or information).

Device 10 may have a phased antenna array 90 of antennas 30 (sometimes also referred to as a phased array antenna having antenna elements formed from antennas 30). Phased antenna array 90 may include M antennas 30 (e.g., a first antenna 30-1, a second antenna 30-2, an Mth antenna 30-M). The M antennas of phased antenna array 90 may lie within a plane 92, sometimes referred to herein as antenna plane 92 (e.g., parallel to the X-Z plane of FIG. 4). In general, the M antennas 30 in phased antenna array 90 may be arranged in any desired one or two dimensional pattern. FIG. 4 illustrates a simplest case in which the M antennas 30 in phased antenna array 90 are arranged in a one dimensional line (e.g., as a linear array), where each antenna 30 is separated from one or two adjacent antennas 30 in the array by distance d.

Wireless signals 46 may be incident upon phased antenna array 90 at an AoA α relative to a normal axis 86 of phased antenna array 90 (e.g., an axis orthogonal to antenna plane 92 and parallel to the Y-axis of FIG. 4). Device 10 may measure the wireless signals 46 received from external device 34 (e.g., device 10 may gather measurements of the phase and/or magnitude of wireless signals 46 and/or may gather any desired wireless performance metric data from the received wireless signals). Wireless signals 46 are incident upon each antenna 30 in phased antenna array 90 at a slightly different time due to the different path lengths the wireless signals traverse in reaching each of the antennas. These time-of-arrival differences are equivalent to each antenna 30 receiving wireless signals 46 at a slightly different phase ϕ, where the difference in phase Δϕ of the received signal between adjacent antennas 30 is given by the equation Δϕ=2π*d*sin(θ)/λ, where λ is the wavelength of wireless signals 46. By measuring the phase of the wireless signals 46 received by each antenna 30, device 10 may calculate AoA α using the equation α=sin⁻¹((Δϕ*λ)/(2π*d). Once device 10 has knowledge of AoA α, device 10 may use the TOF of wireless signals 46 to identify the range to external device 34, which allows device 10 to identify the precise three-dimensional location 82 of external device 34. For the sake of simplicity, FIG. 4 illustrates only the X-Y plane of three-dimensional space. This methodology may be generalized to three-dimensional space if desired. In this way, external device 34 may be localized in three-dimensional space instead of just within the X-Y plane (e.g., device 10 may determine or detect both azimuth and elevation angles or any set of two or more angles characterizing the pointing direction or AoA to/from external device 34).

As each antenna 30 in phased antenna array 90 is coupled to a corresponding receive chain of receiver circuitry in device 10 for receiving wireless signals using that antenna 30 (e.g., where each receive chain includes a corresponding amplifier, phase and magnitude controller, filter circuitry, etc.), detecting the location of external device 34 in this way can consume excessive power, space, and other resources within device 10. In addition, when wireless signals 46 are at sub-THz frequencies or millimeter wave frequencies, the receive chain complexity in device 10 needs to be even higher due to the low power efficiency of existing radio-frequency technologies at such high frequencies. For situations where device 10 needs to concurrently detect the locations of multiple external devices 34, the complexity of the hardware required to support the phased antenna array further increases. For example, phased antenna array 90 generally needs to have more antennas 30 (and thus more receive chains) than the number of external devices 34 for the super-resolution algorithm to recover the AoA to each external device 34.

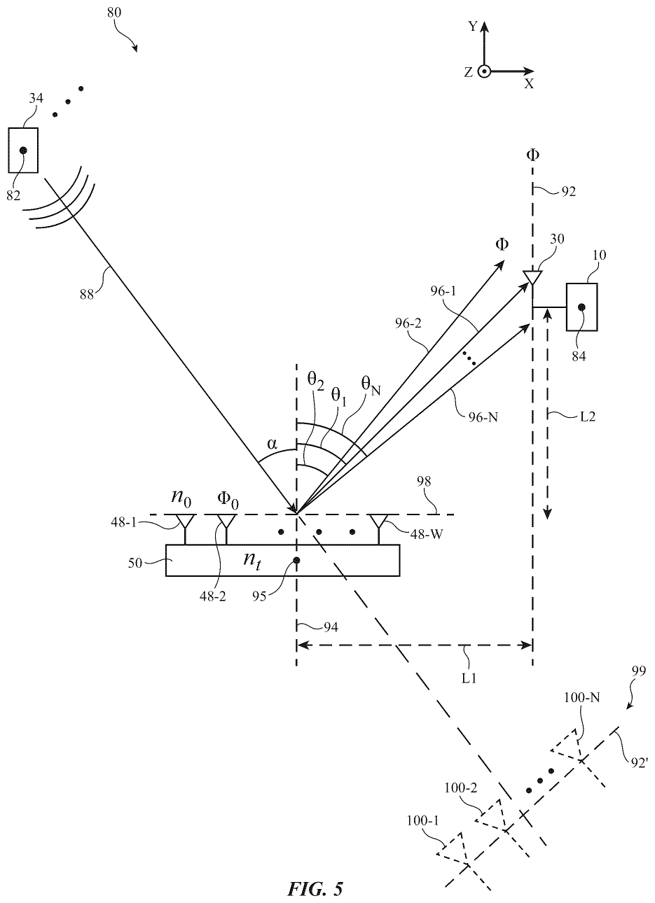

To mitigate these issues, device 10 may detect the location of one or more external devices 34 using one or more RIS's 50. By leveraging RIS 50 in performing localization, device 10 may detect the location of the external device(s) 34 using just a single antenna 30 and a single receive chain, thereby minimizing space, resource, and power consumption on device 10. FIG. 5 is a diagram showing how device 10 may use RIS 50 and a single antenna 30 to detect the location of external device 34.

As shown in FIG. 5, external device 34 may be at location 82, device 10 may be at location 84, and RIS 50 may be at location 95 in area 80. Device 10 may include a single antenna 30 that detects the location of external device 34 using wireless signals 46 received from external device 34 via reflection off RIS 50. Antenna 30 may not form part of any phased antenna array on device 10 or may, if desired, form part of a larger phased antenna array (not shown).

Antenna 30 may have an antenna resonating (radiating) element that lies within antenna plane 92 (e.g., parallel to the Y-Z plane of FIG. 5). The W antenna elements 48 of RIS 50 (e.g., a first antenna element 48-1, a second antenna element 48-2, a Wth antenna element 48-W, etc.) may lie within an antenna plane 98 (e.g., parallel to the X-Z plane of FIG. 5 or, more generally, at any desired orientation relative to antenna plane 92). The dielectric material in RIS 50 (e.g., the substrate for antenna elements 48) may have a reflecting index nt and the air around RIS 50 may have reflecting index no.

Device 10 may have a priori knowledge of the location 95 of RIS 50 (e.g., via initial configuration and establishment of a control RAT and/or data RAT connection between RIS 50 and device 10, via deployment/placement of RIS 50 and device 10 in area 80 by the same user, person, or entity, etc.). For example, device 10 may be separated from RIS 50 by a vector having a projection L1 in a plane parallel to antenna plane 98 of RIS 50 and having a projection L2 in a plane parallel to antenna plane 92 of device 10. Projections L1 and L2 may be known to device 10.

Wireless signals 46 from external device 34 may be incident upon RIS 50 in the direction of arrow 88. Wireless signals 46 may be transmitted by external device 34 or may be transmitted by device 10 (or some other device) and reflected off external device 34 towards RIS 50. Wireless signals 46 may be incident upon RIS 50 at an AoA α relative to the normal axis 94 of the array of antenna elements 48 in RIS 50 (e.g., where normal axis 94 is orthogonal to antenna plane 98).

RIS 50 may reflect the incident wireless signals 46 towards device 10 while sweeping antenna elements 48 through a set of N different RIS beams over time, as shown by arrows 96. N may be any integer greater than or equal to two. The particular RIS beams (as well as the orientation of the RIS beams) and the timing of the sweep over the set of RIS beams (sometimes referred to herein as beam timing) may be known to device 10. Device 10 may, for example, use the control RAT to program or instruct RIS 50 to form the set of RIS beams (e.g., having orientations known to device 10) and to sweep over the set of RIS beams using a predetermined beam timing set by device 10.

Each RIS beam in the set of RIS beams may be labeled by a corresponding index i (where i=1, 2, . . . N). Each RIS beam in the set of RIS beams may be oriented in a different respective direction. When RIS 50 is configured to form a given RIS beam from the set of RIS beams, RIS 50 may reflect the incident wireless signals 46 from the direction of arrow 88 and towards device 10 in the direction of the corresponding arrow 96. For example, when RIS 50 forms a first RIS beam from the set of RIS beams, RIS 50 may reflect wireless signals 46 incident from the direction of arrow 88 onto a first reflected angle θ₁ relative to normal axis 94 (as shown by arrow 96-1), when RIS 50 forms a second RIS beam from the set of RIS beams, RIS 50 may reflect wireless signals 46 onto a second reflected angle θ₂ relative to normal axis 94 (as shown by arrow 96-2), when RIS 50 forms an Nth RIS beam from the set of RIS beams, RIS 50 may reflect wireless signals 46 onto an Nth reflected angle θ_{N} relative to normal axis 94 (as shown by arrow 96-N), etc.

In this way, RIS 50 may effectively reflect wireless signals 46 in different directions as if RIS 50 were a mechanically steerable mirror that is rotated over different angles to reflect the wireless signals in the direction of arrows 96. However, RIS 50 may be more cost effective to implement, consuming less space, being less susceptible to damage, and consuming less power than a mechanically steerable mirror. In addition, mechanically steerable mirrors only allow linear phase changes with position (whereas RIS 50 allows arbitrary phase profiles, which may be utilized to program different parts of the same RIS to focus different incident wireless signals 46), mechanically steerable mirrors are less frequency selective than RIS 50 (e.g., RIS 50 may apply some degree of frequency filtering whereas a mechanically steerable mirror may also reflect undesirable frequencies), and RIS 50 may be electrically adjusted to redirect signals onto different reflected angles much more rapidly than steering a mechanically steerable mirror, which must overcome inertia while steering.

Each RIS beam corresponds to a different respective set of settings for the W adjustable devices 74 of RIS 50 (FIG. 2), which collectively configure the W antenna elements 48 of RIS 50 to form the different RIS beams. For example, each RIS beam may correspond to a set of complex reflection coefficients for antenna elements 48 (e.g., as established using adjustable devices 74), a set of impedances for antenna elements 48 (e.g., impedance settings for adjustable devices 74), or a set of phase shifts imparted to the reflected signals by antenna elements 48 (e.g., as established using adjustable devices 74).

Since each RIS beam is oriented at a different reflected angle θᵢ, the reflected wireless signals 46 travel slightly different path lengths in each RIS beam. This causes the reflected wireless signals 46 to be incident upon antenna 30 with different phases ϕᵢn each of the RIS beams (e.g., when incident upon device 10 in the direction of each of arrows 96). The receive chain in device 10 coupled to antenna 30 may receive the reflected wireless signals 46 from each of the RIS beams in the set of RIS beams and may measure the phase ϕ of the signals received from each of the RIS beams in the set of RIS beams. In other words, device 10 may identify the phase ϕ of wireless signals 46 as reflected in the direction of each of the N arrows 96.

Since device 10 has knowledge of the beam timing of RIS 50, the orientation of each of the RIS beams in the set of RIS beams (e.g., each of reflected angles θᵢ=θ₁, . . . θ_{N}), and the position/orientation of RIS 50 relative to device 10, device 10 may use a single antenna 30 to measure phase ϕ over time (e.g., as RIS 50 sweeps over the set of RIS beams) in a manner that is equivalent to measuring phase differences Δϕ using a phased antenna array 90 of M antennas 30 (FIG. 4). For example, device 10 may generate a steering vector β based on the phases ϕ generated at different times (and the corresponding known reflection angles θᵢ=θ₁, . . . θ_{N}). Device 10 may then input the steering vector to a super-resolution algorithm that outputs AoA α based on the steering vector. Since device 10 has knowledge of the position and orientation of RIS 50 relative to device 10, device 10 may then combine the known position/orientation of RIS 50 with the identified AoA α from external device 34 to RIS 50 and the TOF of the received wireless signals to identify the precise spatial location 82 of external device 34.

In other words, by controlling RIS 50 to reflect wireless signals 46 over the set of RIS beams with known beam timing and reflection angles and sequentially measuring phase at different times (e.g., times corresponding to the known beam timing), device 10 may use just a single antenna 30 and a single receive chain to measure AoA α and thus the location 82 of external device 34 in a manner equivalent to an implementation where device 10 has a phased antenna array of N antennas 30 at different locations 100 (e.g., a first antenna at location 100-1, a second antenna at location 100-2, an Nth antenna at location 100-N, etc.) within an antenna plane 92′ that directly receive wireless signals 48 in the direction of arrow 88 (without reflection off RIS 50). However, since device 10 includes only a single antenna 30, the space, resource, and power consumed by device 10 is minimized.

Consider a simplest case example in which RIS 50 receives wireless signals 46 from only a single external device 34. In this example, device 10 need not generate a steering vector and can instead recover AoA α using a measurement of phase ϕ by antenna 30 at a single time to (e.g., while RIS 50 forms a single RIS beam from the sweep of RIS beams having reflected angle θ₁). For example, device 10 may compute (e.g., measure, produce, output, generate, calculate, etc.) AoA α by combining equation 1 with equation 2 and solving for α.

$$ϕ = {ϕ}_{0} + 2 π \frac{c}{{n}_{0} f} ( \frac{L 1}{sin ( {θ}_{1} )} ) \qquad ( 1 )$$

$${n}_{0} cos ( α ) ( 1 - r ) = {n}_{t} cos ( {θ}_{1} ) ( 1 + r ) \qquad ( 2 )$$

In equations 1 and 2, ϕ₀ is the phase of wireless signals 46 at antenna plane 98 of RIS 50, c is the speed of light, f is the carrier frequency of wireless signals 46, and r is the reflection coefficient of RIS 50.

However, in practice, device 10 has no a priori knowledge that it is receiving wireless signals 46 from only a single external device 34. Device 10 may therefore generate a steering vector and may apply a super-resolution algorithm to the steering vector to identify the AoA of the wireless signals 46 received from an arbitrary number K of external devices 34 at different locations in area 80. Device 10 may generate the steering vector by controlling RIS 50 to sweep over the set of N RIS beams (using predetermined beam timing) while device 10 receives wireless signals 46 reflected off RIS 50 (e.g., as received at RIS 50 from some or all of the arbitrary number K of external devices 34).

In general, RIS 50 may form the i^{th} RIS beam in the set of N RIS beams at a corresponding time tᵢ. At time tᵢ, device 10 may use antenna 30 to measure (e.g., generate, output, produce, detect, etc.) the phase ϕᵢ of the wireless signals 46 received over the i^{th} RIS beam at the i^{th} reflected angle θᵢ (e.g., in the direction of the i^{th} arrow 96). Once device 10 has measured the N phases ϕᵢ, device 10 may combine equations 3-5 to output (e.g., measure, generate, populate, output, produce, detect, etc.) a steering vector β(θᵢ) (e.g., a 1-by-N matrix written as a function of reflected angles θᵢ over time), given by equation 6.

$${ϕ}_{i} = {ϕ}_{0} + 2 π \frac{c}{{n}_{0} f} ( \frac{L 1}{sin ( {θ}_{i} )} ) \qquad ( 3 )$$

$${n}_{0} cos ( α ) ( 1 - r ) = {n}_{t} cos ( {θ}_{i} ) ( 1 + r ) \qquad ( 4 )$$

$$sin ( α ) = f ( {θ}_{i} ) \qquad ( 5 )$$

$$β ( {θ}_{i} ) = ( \begin{matrix}1 \\ f ( {θ}_{1} ) \\ ⋮ \\ f ( {θ}_{N - 1} )\end{matrix} ) \qquad ( 6 )$$

Each of the K external devices 34 (e.g., signal sources of wireless signals 46) may be labeled with a corresponding index k, where k=1, 2, . . . K. The wireless signals 46 received from the k^{th} external device 34 are therefore received from a corresponding respective AoA αₖ. Once device 10 (e.g., control circuitry 14 of FIG. 1) has generated steering vector β(θᵢ), device 10 may input steering vector β(θᵢ) to a super-resolution algorithm that outputs (e.g., generates, produces, computes, calculates, estimates, etc.), based on steering vector β(θᵢ), the K AoA's αₖ for each of the K external devices 34.

In general, any desired super-resolution algorithm may be used (e.g., a subspace decomposition algorithm such as the Multiple Signal Classification (MUSIC) algorithm, compressed-sensing based algorithms, etc.). The MUSIC algorithm, for example, is based on the equation M_{N×1}=A_{N×K}S_{K×1}+V_{N×1}, where A is the steering vector, S is a vector including the measured amplitude of the K signal sources (external devices 34), M is a vector of N measurements from N reflected RIS beams (reflected angles θ), and V is the additive white Gaussian (AWG) noise vector. The MUSIC algorithm outputs a signal P_{MUSIC}, given by equation 7, which exhibits peaks when the AoA is equal to αₖ (e.g., peak detection may be used to obtain the AoA's αₖ).

$${P}_{MUSIC} = \frac{1}{{β}^{H} ( {θ}_{i} ) {Q}_{N} {Q}_{N}^{H} β ( {θ}_{i} )} \qquad ( 7 )$$

In equation 7, ( )^{H} is the Hermitian transpose operator and Q_{N} is the noise subspace. In general, to resolve each of the K AoA's αₖ, N needs to be greater than K.

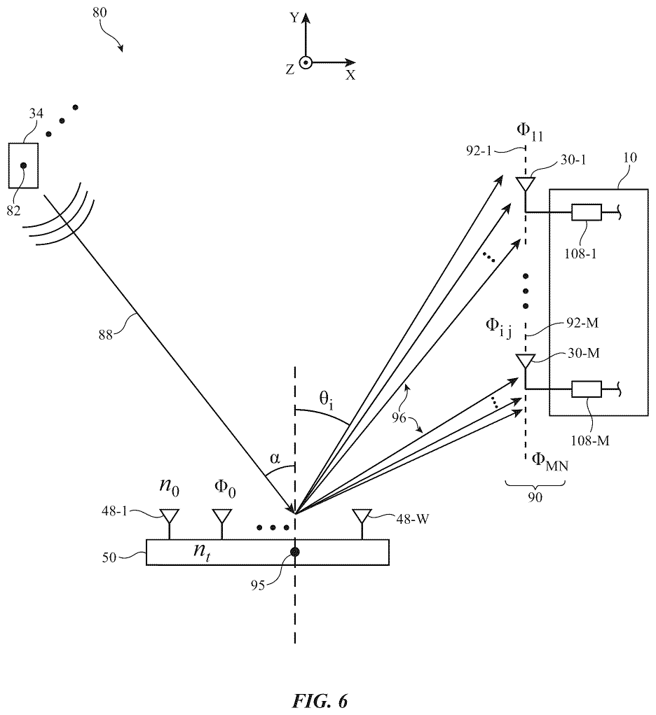

The example of FIG. 5 is illustrative and non-limiting. Any desired super-resolution algorithm may be used to obtain AoA's αₖ. FIG. 5 illustrates a simplest example in which the W antenna elements 48 in RIS 50 are arranged in a one-dimensional linear pattern. The operations described herein may be generalized to implementations in which antenna elements 48 are arranged in any desired one, two, or three-dimensional pattern and where device 10 is at any desired orientation/position relative to RIS 50. In general, the particular super-resolution algorithm and the equations used to obtain AoA's αₖ will depend on the geometry of device 10, RIS 50, etc. FIG. 5. shows an example where the reflection of RIS 50 according to selected RIS codebook entries can be interpreted to cause virtual locations of antenna 30 at locations 100-1 through 100-N. However, less structured settings of codebook entries can be selected in general. This may require corresponding adaptations of the super resolution algorithm. In general, each additional codebook setting (entry) applied to RIS 50 enables an additional measurement at antenna 30, which provides additional information to device 10. Combining all these measurements, the algorithm can deduct the desired information (e.g., identifying the position of external device 34). The more measurements that are available, the more accuracy and precision achievable by such algorithms. In other words, the larger the steering vector, the better the positioning resolution that can be achieved. If desired, device 10 may implement a hybrid approach to detecting AoA's αₖ using a phased antenna array 90 having M antennas 30, as shown in the example of FIG. 6.

As shown in FIG. 6, device 10 may have M antennas 30 arranged within phased antenna array 90. Each antenna 30 may be coupled to respective receive chain (path) 108 (e.g., antenna 30-1 may be coupled to receive chain 108-1, antenna 30-M may be coupled to receive chain 108-M, etc.). Each of the M antennas 30 and the corresponding M receive chains 108 may be labeled by a corresponding index j, where j=1, 2, . . . , M. Each antenna 30 may lie within a respective antenna plane 92 (e.g., antenna 30-1 may lie within antenna plane 92-1, antenna 30-M may lie within antenna plane 30-M, etc.).

In these implementations, device 10 may control RIS 50 to steer over N different RIS beams 50 (e.g., incident upon device 10 from M*N different reflected angles) and may gather M*N measurements (e.g., N measurements from each of the M antennas 30) from the reflected signals 46 incident upon device 10. The reflected signals received over the i^{th} RIS beam are incident upon the j^{th} antenna 30 at a corresponding phase ϕᵢⱼ (e.g., from a first phase ϕ₁₁ for the signals received over the i=1 RIS beam by antenna 30-1 to an M*Nth phase ϕ_{MN} for the signals received over the i=N RIS beam by antenna 30-M).

Device 10 may generate or accumulate a steering vector β(θⱼᵢ) from the measurements, where steering vector β(θⱼᵢ) is a 1-by-M*N vector β(θⱼᵢ)=[1, f(θ₁₁), . . . , f(θ_{MN})]. Device 10 may input the steering vector to the super-resolution algorithm to identify AoA's αₖ. The MUSIC algorithm, for example, may output M*N different AoA's αₖ (e.g., from N measurements performed by each of the M antennas 30 on wireless signals 36 received from the K external devices 34). Implementing device 10 in this way may allow device 10 to exhibit greater AoA resolution than when a single antenna 30 is used and can allow device 10 to detect a greater number of external devices 34, but consumes more power and other resources than when a single antenna 30 is used.

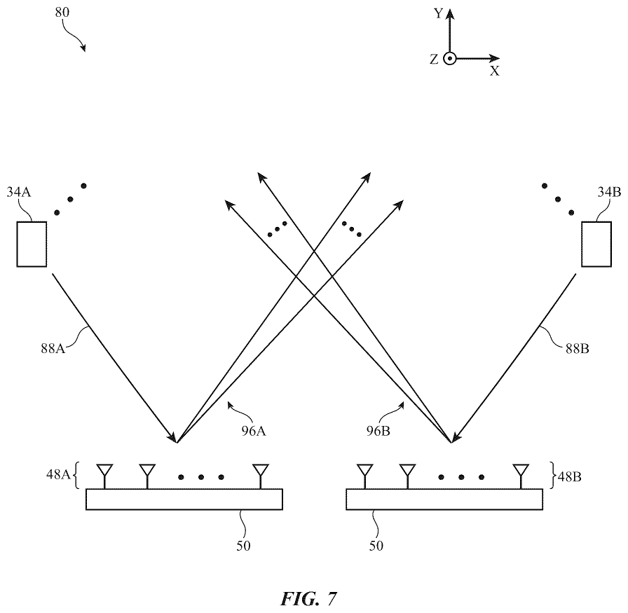

The examples of FIGS. 5 and 6 in which device 10 measures AoA using a single set of antenna elements 48 on a single RIS 50 is illustrative and non-limiting. If desired, device 10 may use wireless signals 46 reflected from multiple sets of antenna elements 48 distributed across one or more RIS's to detect AoA. FIG. 7 shows one example of how a first set of antenna elements 48A and a second set of antenna elements 48B may be used to detect AoA.

As shown in FIG. 7, device 10 may program a first set of antenna elements 48A to sweep over a first set of RIS beams, as shown by arrows 96A, and may program a second set of antenna elements 48B to sweep over a second set of RIS beams, as shown by arrows 96B. Device 10 has been omitted from FIG. 7 for the sake of clarity but may, if desired, include a single antenna 30 as shown in FIG. 5 or M antennas 30 as shown in FIG. 6. Antenna elements 48A and 48B may be independently configured sets of antenna elements 48 on the same RIS 50 (e.g., disposed on separate regions of RIS 50 or interspersed with each other on RIS 50) or may, if desired, be disposed on separate RIS's 50.

Antenna elements 48A may reflect wireless signals 46 incident (e.g., as shown by arrow 88A) from a first set of one or more external devices 34A towards device 10 (e.g., as shown by arrows 96A). Antenna elements 48B may concurrently reflect wireless 46 incident (e.g., as shown by arrow 88B) from a second set of one or more external devices 34B towards device 10 (e.g., as shown by arrows 96B). Device 10 may measure the reflected wireless signals (e.g., using different respective antenna(s) 30 that receive the wireless signals reflected from antenna elements 48A and the wireless signals reflected from antenna elements 48B), may generate a steering vector based on the measurements, and may generate AoA's to external device(s) 34A and/or external device(s) 34B based on the steering vector and the super-resolution algorithm. Receiving reflected signals from multiple sets of antennas 48 (e.g., from multiple RIS's 50) at different locations and/or orientations can help increase the number of detectable external devices 34, the accuracy of the AoA estimation, and/or the field of view over which the wireless signals can be received, as examples.

If desired, the antenna elements 48 may focus wireless signals 46 upon reflection towards device 10. For example, as shown in FIG. 8, RIS 50 may receive wireless signals 46 within cone 120. RIS 50 may reflect wireless signals 46 within a focused cone 122. The antenna elements 48 on RIS 50 may, for example, impart the reflected signals with different phases that effectively serve to narrow or focus the wireless signals. By focusing the reflected signals in this way, RIS 50 may function similar to a concave radio-frequency mirror and may help to increase the received power of the wireless signals at device 10.

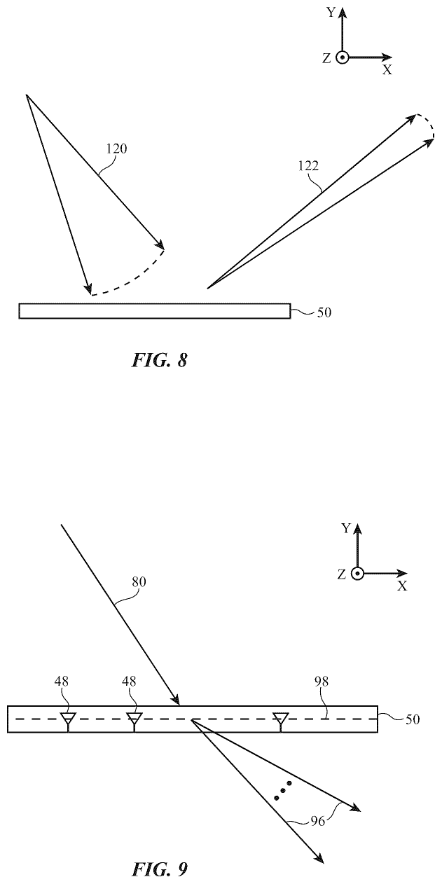

The examples of FIGS. 1-8 in which RIS 50 reflects wireless signals 46 is illustrative and non-limiting. If desired, RIS 50 may (passively) transmit wireless signals 46 in different directions (e.g., as given by the RIS beams formed by antenna elements 48) rather than (passively) reflecting the wireless signals. For example, as shown in FIG. 9, wireless signals 46 may be incident upon RIS 50 from a first side of antenna plane 98 (e.g., in the direction of arrow 80). Antenna elements 48 may transmit the wireless signals through RIS 50 rather than reflecting the wireless signals, outputting the wireless signals at an opposing second side of antenna plane 98 (e.g., in the direction of arrows 96). Antenna elements 48 may impart different phases to the wireless signals when transmitting the wireless signals, causing the wireless signals to be transmitted in different directions (e.g., effectively forming an electrically steerable radio-frequency lens or prism). While referred to as transmitting the wireless signals, the antenna elements of RIS 50 do not actively transmit any signals (e.g., RIS 50 may be transparent to the signals while imparting different phases to the signals passing through the RIS at the location of each antenna element of the RIS, causing the signals passing through the RIS to be output in a desired direction over a corresponding RIS beam). RIS 50 may steer the transmitted signals over N different directions (e.g., as shown by arrows 96) for receipt by device 10 (e.g., as shown in FIGS. 5 and 6). If desired, the RIS may focus the wireless signals upon transmission (e.g., similar to as shown in FIG. 8). If desired, RIS 50 may switch, over time, between a first mode in which antenna elements 48 reflect signals (e.g., as shown in FIGS. 1-8) and a second mode in which antenna elements 48 transmit signals. A RIS 50 that transmits wireless signals 46 in this way may sometimes also be referred to herein as a transmissive intelligent surface (TIS) or transmissive RIS. A RIS 50 that reflects wireless signals 46 may sometimes also be referred to herein as a reflective RIS. RIS 50 may be, if desired, both a reflective RIS and a transmissive RIS (e.g., may be controlled to switch between being a transmissive RIS and a reflective RIS).

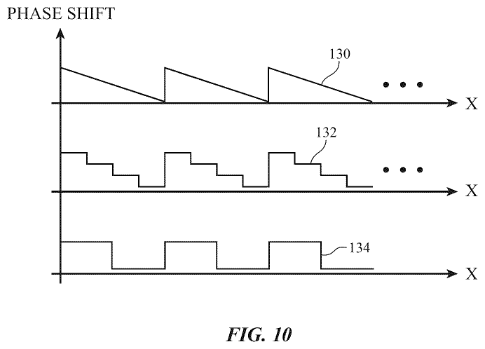

FIG. 10 shows three examples of phase profiles that may be exhibited by the antenna elements 48 on RIS 50, if desired. The curves of FIG. 10 plot the phase shift imparted by different antenna elements 48 on RIS 50 as a function of position along antenna plane 98 (e.g., at different positions along the X-axis of FIGS. 5-9). If desired, similar phase shift profiles may be applied along the Y-axis, even at the same time, giving a compound phase profile over the X-Y plane.

As shown by curve 130, the antenna elements 48 of RIS 50 may be configured to exhibit a phase profile that is periodically and continuously decreasing as a function of position. This may configure antenna elements 48 to reflect wireless signals 46 as if the antenna elements 48 formed a Fresnel mirror (or a Fresnel lens when RIS 50 is a transmissive RIS). As shown by curve 132, the phase profile may periodically decrease in discrete steps rather than continuously. This may, however, generate undesirable signal sidelobes that can increase measurement inaccuracy. As shown by curve 130, the antenna elements 48 of RIS 50 may be configured to exhibit a binary phase profile that is periodically cycled between two different values (e.g., phases of 0 or 180 degrees). This may produce the desired reflection but also strong sidelobes. The presence of sidelobes can somewhat degrade RIS communication performance but does not necessarily affect AoA estimation since device 10 can simply utilize additional measurements to satisfy additional equations to resolve AoA and does not necessarily require RIS 50 to exhibit perfect reflection. In general, RIS 50 may exhibit any desired phase profile. Since RIS 50 is programmable, RIS 50 may be adjusted between these or other phase profiles over time.

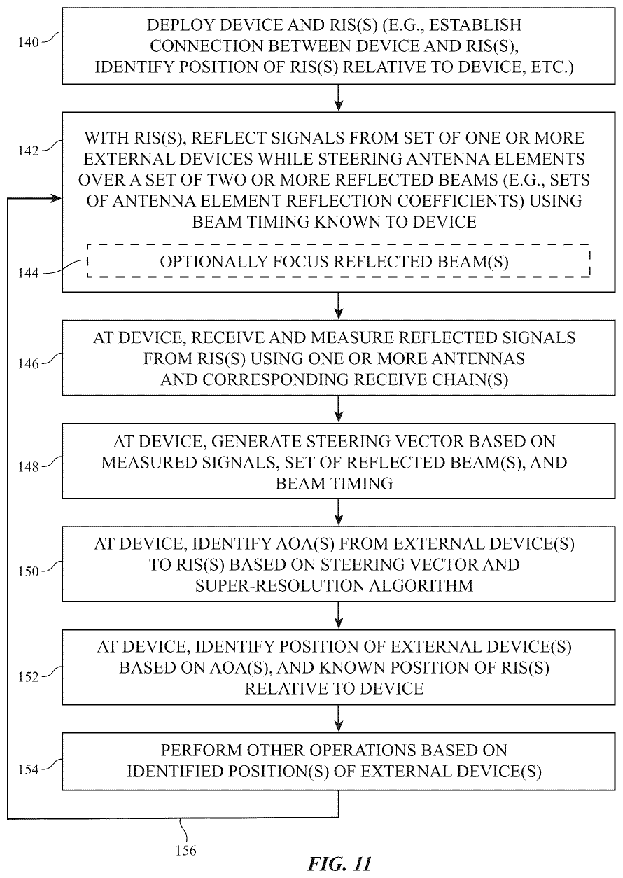

FIG. 11 is a flow chart of illustrative operations involved in detecting the AoA of one or more external devices 34 at device 10. At operation 140, device 10 and one or more RIS's 50 may be deployed in area 80. If desired, the same user, person, administrator, or entity may deploy or place device 10 and RIS(s) 50 at known locations in area 80. Once deployed, device 10 may establish communications with each of the RIS(s) and may configure the reflection coefficients of each of the RIS(s).

For example, device 10 may perform the RIS discovery using control RAT 60 (FIG. 2). The RIS discovery may serve to identify, to device 10, the presence of the RIS(s) 50 available for reflection of wireless signals 46 for use in position detection and may serve to establish a control RAT connection between the device 10 and those RIS(s). Alternatively, a control device other than device 10 may discover RIS(s) 50. Once device 10 (or the control device) has discovered the RIS(s), device 10 is aware of the presence of the RIS(s) in the system and can use those RIS's to perform localization one external device(s) 34.

If desired, device 10 may then perform a RIS initialization on the discovered RIS's in system 8 using the control RAT. This may involve using the control RAT to exchange capability information and/or location information between the control device and the discovered RIS's. The location information may include information identifying the location/position of RIS 50 (e.g., in absolute coordinates). The capability information may include information identifying one or more capabilities of the RIS's. The capability information may include, for example, information identifying the modulation/multiplexing capabilities of the RIS, information identifying how to utilize and control the modulation/multiplexing capabilities (e.g., mechanisms for setting phase shifts of the antenna elements, channel information, etc.), information about a geometry of the RIS and/or its antenna elements 48, etc. Once the initialization is complete, the control device may have knowledge of the precise (e.g., absolute) location of each RIS as well as information identifying the modulation/multiplexing capabilities of the RIS and how to utilize and control the modulation/multiplexing capabilities.

Device 10 (or the control device) may then configure one or more data RAT reflection characteristics of each initialized RIS (e.g., using control signals conveyed over the control RAT) based on the RIS capability information received during the RIS initialization. This may include, for example, programming each RIS to form a corresponding set of N different RIS beams directed towards device 10, information identifying the beam timing with which the RIS is to sweep over the set of RIS beams, etc.

At operation 142, RIS(s) 50 may reflect wireless signals 46 incident from a set of one or more (e.g., a number K) different external devices 34 towards device 10. Each RIS 50 may sweep over its configured set of N RIS beams while reflecting the wireless signals (e.g., as shown by arrows 96 of FIGS. 5 and 6). Each RIS may sweep over its set of RIS beams according to its corresponding beam timing. Device 10 may preconfigure the RIS to exhibit its corresponding beam timing prior to operation 142 (e.g., during operation 140) or may, if desired, actively issue commands to the RIS (e.g., via the control RAT) while the RIS forms each RIS beam in the sweep to periodically instruct the RIS to move to the next RIS beam in its set of RIS beams. If desired, one or more of the RIS's may focus the reflected wireless signals at optional operation 144 (e.g., as shown in FIG. 8). If desired, one or more of the RIS's may transmit the wireless signals instead of reflecting the wireless signals (e.g., as shown in FIG. 9). If desired, device 10 may control one or more of the RIS's to switch between reflecting wireless signals (e.g., as shown in FIGS. 5-8) and transmitting the wireless signals (e.g., as shown in FIG. 9) at different times.

While operation 146 is shown separately from operation 142 in FIG. 11 for the sake of clarity, operation 146 may be performed concurrently with operation 144. At operation 146, device 10 may receive and measure the wireless signals 46 reflected by RIS(s) 50 while the RIS(s) form each of the RIS beams in the corresponding beam sweep(s) (e.g., while the wireless signals are incident upon device 10 at each of the N reflected angles θᵢ of the RIS(s)). Device 10 may, for example, measure the magnitude and/or phase of the received wireless signals and/or any desired wireless performance metric data from the received wireless signals. Device 10 may receive and measure wireless signals 46 using a single antenna 30 and its corresponding receive chain (e.g., as shown in FIG. 5) or using M different antennas 30 and receive chains 108 (e.g., as shown in FIG. 6).

At operation 148, control circuitry 14 on device 10 may generate (e.g., estimate, compute, calculate, produce, output, etc.) a steering vector β from the measurements of the reflected wireless signals (e.g., β(θᵢ) when received over one antenna 30 (FIG. 5) or β(θⱼᵢ) when received over M antennas 30 (FIG. 6)).

At operation 150, control circuitry 14 on device 10 may generate (e.g., identify, estimate, recover, detect, compute, calculate, produce, output, etc.) the AoA αₖ to each of the K external device(s) 34 based on the steering vector and a super-resolution algorithm (e.g., the MUSIC algorithm). Control circuitry 14 may, for example, input the steering vector to the super-resolution algorithm, which outputs AoA(s) αₖ.

At operation 152, control circuitry 14 on device 10 may generate (e.g., identify, estimate, recover, detect, compute, calculate, produce, output, etc.) the position(s) of the external device(s) 34 based on the AoA(s), the TOF(s) of the received wireless signals (e.g., as identified from the measured signals), and the known position(s)/orientation(s) of the RIS(s) relative to device 10 (e.g., as established during operation 140). Control circuitry 14 may, for example, identify that external device 34 of FIGS. 5 and 6 is at location 82.

At operation 154, device 10 may perform any other desired operations based on the location(s) of external device(s) 34. As an example, an application processor on device 10 may provide the location(s) as an input to one or more software applications, as a user input, etc. Processing may then loop back to operation 142 via path 156 as external device localization operations continue over time.

The example of FIGS. 4-11 in which device 10 detects the position of external device 34 based on the detected AoA of wireless signals 46 upon RIS 50 is illustrative and non-limiting. If desired, device 10 may detect the position of external device 34 based on one or more other characteristics of the wireless signals 46 incident upon RIS 50 (e.g., using RIS 50) in addition to or instead of the AoA of wireless signals 46. For example, like AoA, device 10 may determine or detect other parameters of the wavefront of wireless signals 46 incident on RIS 50 in a similar manner and/or using similar approaches as described herein. Such parameters may include, for example, the divergence and/or convergence of the waves of wireless signals 46 (e.g., the degree to which the wavefront spreads out or focuses while propagating) and/or other characteristics that define the wavefront more precisely than simply giving the dominant direction of the signals as incident upon RIS 50. Consequently, these parameters may be used to derive more general information about the transmission source (e.g., external device 34) than its position (e.g., more specific characteristics of the transmission like angular distribution of transmission or transmission divergence).

In addition to or instead of identifying the position of external device 34 in spatial (position) coordinates, device 10 may detect or characterize the position of external device 34 as a full three-dimensional rotation or relative orientation between two devices, if desired. A full three-dimensional rotation or relative orientation between two devices (e.g., device 10, external device 34, and/or RIS 50) is defined by at least three angles such as azimuth, elevation, and tilt angels or yaw, pitch, and roll angles. One of these angles (e.g., tilt or roll) may describe the rotation around the axis connecting (intersecting) the two devices. In case of any relative rotation between the two devices, rotation angle estimation can be considered as an important parameter to exactly determine the position of one or more of the devices (e.g., external device 34). Polarization may, for example, be measured or observed at device 10 using cross-polarized antennas, which may help to detect the third (e.g., missing) angle. However, the polarization may not survive or may be affected by intervening reflections such as reflection off RIS 50 and/or passage through different media. This effect is sometimes referred to as polarization mixing. In some implementations, the radiation of wireless signals 46 is not polarized at the source, or it can be difficult or expensive to transmit polarized wireless signals or to measure polarization (e.g., requiring specific polarized antenna structures and more or more extensive transmit/receive structures). In these cases, it may be possible to use radiation with different properties in the direction of travel (e.g., wireless signals having a larger beam divergence horizontally than vertically or in an any other directions). Then, by determining such beam characteristics, it may be possible to infer the missing angle for a full 3D angular determination.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

The methods and operations described above in connection with FIGS. 1-11 may be performed by the components of device 10, RIS 50, and/or external device 34 using software, firmware, and/or hardware (e.g., dedicated circuitry or hardware). Software code for performing these operations may be stored on non-transitory computer readable storage media (e.g., tangible computer readable storage media) stored on one or more of the components of device 10, RIS 50, and/or external device 34. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10, RIS 50, and/or external device 34. The processing circuitry may include microprocessors, central processing units (CPUs), application-specific integrated circuits with processing circuitry, or other processing circuitry.

Device 10 and/or external device 34 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device comprising:
an antenna configured to receive wireless signals redirected by a reconfigurable intelligent surface (RIS); and
one or more processors configured to detect, based on the wireless signals received by the antenna, an angle-of-arrival (AoA) of the wireless signals at the RIS.

2. The electronic device of claim 1, wherein the wireless signals are at a frequency greater than or equal to 100 GHz.

3. The electronic device of claim 1, wherein the wireless signals are incident upon the antenna in a first direction from the RIS at a first time and are incident upon the antenna in a second direction from the RIS at a second time.

4. The electronic device of claim 3, the one or more processors being further configured to perform a first measurement of the wireless signals at the first time, to perform a second measurement of the wireless signals at the second time, and to detect the AoA based on the first measurement and the second measurement.

5. The electronic device of claim 4, the one or more processors being further configured to:
generate a steering vector based on the first measurement and the second measurement, and
detect the AoA based on the steering vector.

6. The electronic device of claim 5, the one or more processors being further configured to detect the AoA based on a super-resolution algorithm having the steering vector as an input.

7. The electronic device of claim 1, wherein at least some of the wireless signals are incident upon the RIS from a first external device, the one or more processors being further configured to detect a position of the first external device based on the AoA of the wireless signals at the RIS.

8. The electronic device of claim 7, the one or more processors being further configured to detect, based on the wireless signals received by the antenna, an additional AoA of the wireless signals at the RIS.

9. The electronic device of claim 8, wherein at least some of the wireless signals are incident upon the RIS from a second external device different from the first external device, the one or more processors being further configured to detect a position of the second external device based on the additional AoA of the wireless signals at the RIS.

10. The electronic device of claim 1, wherein the wireless signals are conveyed using a first radio access technology (RAT), the one or more processors being further configured to program, using a second RAT different from the first RAT, the RIS to perform a sweep over different impedances of antenna elements on the RIS while the RIS redirects the wireless signals.

11. The electronic device of claim 10, the one or more processors being further configured to control the RIS to focus the wireless signals upon redirection.

12. The electronic device of claim 10, the one or more processors being further configured to control the RIS switch between a first mode in which the RIS reflects the wireless signals and a second mode in which the RIS transmits the wireless signals.

13. A method of operating an electronic device to detect a position of one or more external devices, the method comprising:
receiving, using one or more antennas, wireless signals reflected by a reconfigurable intelligent surface (RIS) over a set of different reflected angles; and
detecting, using one or more processors, the position of the one or more external devices based on the wireless signals received using the one or more antennas.

14. The method of claim 13, the one or more antennas comprising at least a first antenna and a second antenna from a phased antenna array on the electronic device, wherein receiving the wireless signals comprises:
receiving, using the first antenna, the wireless signals reflected by the RIS over the set of different reflected angles; and
receiving, using the second antenna, the wireless signals reflected by the RIS over the set of different angles.

15. The method of claim 14, wherein the first antenna receives the wireless signals from a first set of antenna elements on the RIS and the second antenna receives the wireless signals form a second set of antenna elements on the RIS.

16. The method of claim 13, further comprising:
receiving, using one or more additional antennas, additional wireless signals reflected by an additional RIS over an additional set of different reflected angles; and
detecting, using one or more processors, the position of the one or more additional external devices based on the additional wireless signals received using the one or more additional antennas.

17. The method of claim 14, wherein the one or more antennas comprises a single antenna coupled to a corresponding receive chain.

18. The method of claim 13, wherein detecting the position of the one or more external devices comprises:
performing measurements, using the one or more processors, of the wireless signals reflected by the RIS at each reflected angle in the set of different reflected angles;
generating, based on the measurements, a steering vector;
detecting, based on the steering vector and a super-resolution algorithm, one or more angles-of-arrival of the wireless signals at the RIS; and
detecting, based on the one or more angles-of-arrival, the position of the one or more external devices.

19. An electronic device comprising:
a phased antenna array having at least a first antenna and a second antenna, each configured to receive wireless signals reflected by a reconfigurable intelligent surface (RIS) while the RIS sweeps over a set of different reflected angles at different times; and
one or more processors configured to
perform first measurements of the wireless signals received by the first antenna,
perform second measurements of the wireless signals received by the second antenna, and
detect, based on the first measurements and the second measurements, a position of at least one external device that is different from the RIS.

20. The electronic device of claim 19, the one or more processors being further configured to:
generate, based on the first measurements and the second measurements, a steering vector;
detect, based on the steering vector and a super-resolution algorithm, one or more angles-of-arrival of the wireless signals at the RIS; and
detect, based on the one or more angles-of-arrival, the position of the at least one external device.
